(19) United States
(12) Patent Application Publication
(10) Pub. No.: US 2013/0110511 A1
(43) Pub. Date: May 2, 2013

(54) System, Method and Program for Customized Voice Communication

(71) Applicants: Murray Spiegel, Roseland, NJ (US); John R. Wullert, II, Martinsville, NJ (US)

(72) Inventors: Murray Spiegel, Roseland, NJ (US); John R. Wullert, II, Martinsville, NJ (US)

(73) Assignee: TELCORDIA TECHNOLOGIES, INC., Piscataway, NJ (US)

(21) Appl. No.: 13/285,763

(22) Filed: Oct. 31, 2011

(51) Int. Cl. G10L 15/00

(52) U.S. Cl. 704/243; 704/231; 704/E15.001

(57) ABSTRACT

A method for customized voice communication comprising receiving a speech signal, retrieving a user account including an user profile corresponding to an identifier of a caller producing the speech signal, and determining if the user profile includes a speech profile with at least one dialect. If the user profile includes a speech profile, the method further comprises analyzing using a speech analyzer on the speech signal to classify the speech signal into a classified dialect, comparing the classified dialect with each of the dialects in the user profiles to select one of the dialects, and using the selected dialect for subsequent voice communication with the user. The selected dialect can be used for subsequent recognition and response speech synthesis. Moreover, a method is described for storing a user's own pronunciation of names and addresses, whereby a user may be greeted by the communication device using their own specific pronunciation.

### FIELD OF THE INVENTION

This invention relates to a system, method and program for customizing voice recognition and voice synthesis for a specific user. In particular, this invention relates to adapting voice communication to account for the manner, style and dialect of a user.

### BACKGROUND

Many systems use voice recognition and voice synthesis for communicating between a machine and a person. These systems generally use a preset dialect and style for the interaction. The preset dialect is used for voice recognition and synthesis. For example, a call center uses one preset dialect for a given country. Additionally, the dialogs most commonly used are limited, such as “Press 1 for English, Press 2 for Spanish” etc. These systems only focus on what people say, rather than how the person is saying it.

Furthermore, when addressing a person or confirming a name and address, the most common pronunciation of the name is used, even if the pronunciation varies on an individual basis. Alternatively, the user must spell the first few letters of the name for the system to recognize the name.

### SUMMARY OF THE INVENTION

Accordingly, disclosed is a method for customized voice communication comprising receiving a speech signal, retrieving an user account including an user profile corresponding to an identifier of a caller producing the speech signal, and determining if the user profile include a speech profile including at least one dialect. If the user profile includes a speech profile, the method further comprises analyzing using a speech analyzer the speech signal to classify the speech signal into a classified dialect, comparing the classified dialect with each of the at least one dialect in the user profile to select one of the at least one dialect; and using the selected one of the at least one dialect for subsequent voice communication based upon the comparing including subsequent recognition and response speech synthesis.

Also disclosed is a method for customized voice communication comprising receiving a speech signal, retrieving an user account including an user profile corresponding an identifier of a caller producing the speech signal, obtaining a textual spelling of a word in the user profile; searching a pronunciation dictionary for a list of available pronunciations for the word; analyzing using a speech analyzer the speech signal to obtain a user pronunciation for the word to output a processed result, comparing the processed result with each of the available pronunciations in the list of available pronunciation, selecting a pronunciation for the word based upon the comparing, and using the selected pronunciation for subsequent voice communication.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 illustrates an exemplary voice communication system in accordance with the invention;

FIG. 2 illustrates a flow chart for customizing a pronunciation of a name on an individual basis in accordance with the invention;

FIG. 3 illustrates a second exemplary voice communication system in accordance with the invention;

FIG. 4 illustrates a flow chart for a customized voice communication on an individual basis in accordance with the invention;

FIG. 5 illustrates a flow chart for voice analysis in accordance with the invention; and

FIG. 6 illustrates a flow chart for updating a dialect in accordance with the invention.

### DETAILED DESCRIPTION OF THE INVENTION

Inventive systems, methods and programs for customizing voice communication are presented. The systems, methods and programs described herein allow for individually tailored voice communication between an individual and a machine, such as a computer.

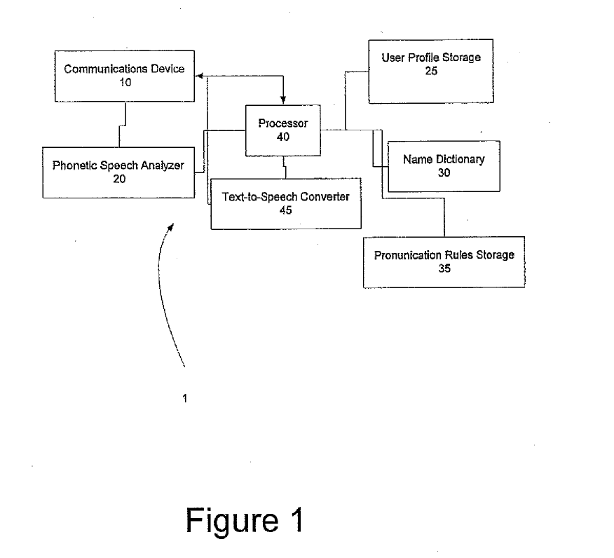

FIG. 1 illustrates an exemplary voice communication system 1 according to the invention. The voice communication system 1 can be a system used in a call center, by providers of IVR (Interactive Voice Response) systems, service integrators, health care providers, drug companies, security companies, providers of speech security solutions, hotels and providers of hotel systems, sales staff; brokerage firms, on-line computer video games, schools, and universities. The use of the voice communication system 1 is not limited to the listed locations and can be used in any automated inbound and outbound user contact. The voice communication system 1 allows a voice to be synthesized to greet a person by name, using their own pronunciation for their name, street address or any other word or phrase.

The voice communication system 1 includes a communications device 10, a phonetic speech analyzer 20, a processor 40, and a text-to-speech converter 45. Additionally, the voice communication system 1 includes user profile storage 25, a name dictionary 30 and pronunciation rules storage 35.

The communications device 10 can be any device capable of communication. For example, the communications device 10 can be, but is not limited to, a cellular telephone, PDA, wired telephone, a network enabled video game console or a computer. The communications device 10 can communicate using any available network, such as, public switched telephone network (PSTN), cellular (RF networks), other wireless telephone or data network, fiber optics and the Internet or the like. FIG. 1 illustrates the communications device 10 separate from the processor 40, however, the two can be integrated.

The processor 40 can be a CPU having volatile and non-volatile memory. The processor 40 is programmed with a program that causes the processor 40 to execute the methods described herein. Alternatively, the processor 40 can be an application-specific integrated circuit (ASIC), a digital signal processing chip (DSP), field programmable gate array (FPGA), programmable logic array (PLA) or the like.

The phonetic speech analyzer 20 also can be included in the processor 40. For illustrative purposes, FIG. 1 illustrates the phonetic speed analyze 20 separately. The phonetic speech analyzer 20 can be software based, for example, being built into a software application run on the processor 40. Additionally, the phonetic speech analyzer 20 can be partially or totally built into the hardware. A partial hardware implementation can be, for example, the implementation of functions in integrated circuits and having the functions invoked by a software application. The phonetic speech analyzer 20 analyzes the speech pattern and outputs a likely set of phonetic classes for each of the sampling periods. For example, the classes can be a) fricative, liquid glide, front (mid-open vowel), voiced dental, unvoiced velar, back (closed vowel), etc or b) Hidden Markov Models (“HMM”) of Cepstral coefficients, or (c) any other method for speech recognition. The classes are stored in the processor 40.

The user profile storage 25 is a database of all user accounts that have registered with a particular organization or entity that is using the voice communication system 1. The user profile includes identifying information, such as a user name, a telephone number, and address. The user profile can be indexed by telephone number or any equivalent unique identifier. Additionally, the user profile can include any special pronunciation for the name and/or address previously determined.

The name dictionary 30 contains a list by name of common (and not so common) pronunciations of names for people and places. The name dictionary 30 can include a ranking system that ranks the pronunciations by likely pronunciations, i.e., more common pronunciations are listed first. Additionally, if the pronunciations are ranked, the ranking can include different tiers. The first tier includes the most common pronunciation group, the second tier includes the second most common pronunciation group and so on. Initially, when the name dictionary 30 is checked for pronunciations, the pronunciations in the first tier are provided. Sequential pronunciation retrievals for the same name provide additionally tiers for comparisons.

The pronunciation rules storage 35 includes common rules for pronunciation (the “Rules”). The Rules 35 can be used when a match was not found via the name dictionary 30 and speech analysis. Additionally, the Rules 35 can be used to confirm the findings of the name dictionary 30 and speech analysis. The Rules 35 are letter-to-sound rules, such as provided by The Telcordia Phonetic Pronunciation Package, which also includes the name dictionary 30. Alternatively, the name dictionary 30 and Rules 35 can be separate. FIG. 1 illustrates the name dictionary 30 and Rules 35 separate for illustrative purposes only.

Both the name dictionary 30 and Rules 35 provide the functionality that output multiple pronunciations for the same name The name dictionary 30 is used, for instance, for the purpose of expedience, when the names with different pronunciations do not share many characteristics with each other, as in Koch and Smyth. Different pronunciations are handled by the Rules 35 when, by virtue of relatively small changes in a specific letter-to-sound rule, similar alternate pronunciations can be output for a (possibly large) number of names that share some characteristic, as in “a” in names like Cassani, Christiani, Giuliani, Marchisani, Sobhani, etc.

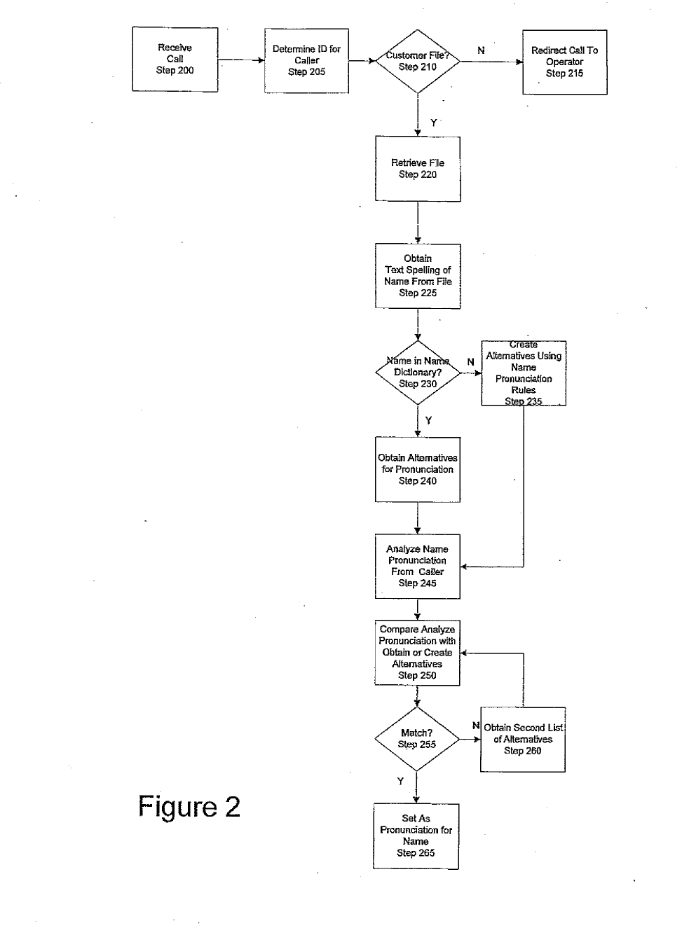

FIG. 2 illustrates an exemplary method for customizing voice communication in accordance with the invention. At step 200, a call is received by the communications device 10. However, although FIG. 2 shows a method where a person initiates the call into the voice communication system 1, the voice communication system 1 can initiate the call. If the voice communication system 1, initiates the call, step 200 is replaced with initiate a call. (Steps 205-220 would be eliminated). The ID for the caller would be known since the voice communication system 1 initiated the call. Additionally, the user file and user profile would also be known.

At step 205, the voice communication system 1 determines the identifier for the caller. The identifier can be a caller ID, obtained via automated number identification (ANI), dialed number information service (DNIS) or by prompting the user for an account number or account identifier.

At step 210, the processor 40 determines if there is a user file associated with the identifier of the caller. If there is a file (“Y” at step 210), the file is retrieved from the user profile storage 25 at step 220. If there is no file (“N” at step 210), the person is redirected to an operator at step 215. Alternatively, the person can be prompted to re-enter the account number.

At step 225, the processor 40 obtains a text spelling of the person's name or address from the user profile in the user file. The name dictionary 30 is checked to see if at least one pronunciation is associated with the person's name at step 230. If there is no available pronunciation (“N” at step 230), Rules 35 is consulted at step 235. However, if there is at least one pronunciation, the available pronunciations are retrieved for comparison with a sample of the person's speech at step 240. As described above, the available pronunciations can be ranked by commonality and grouped by tier. Initially, the processor 40 can retrieve only the first tier pronunciations for comparison.

At step 245, a speech sample is analyzed. The processor 40 prompts the person or user to say his or her full name or address. The name and/or address capture can be explicit or covert, as when requesting a shipping location for a product or service. Alternatively, the processor 40 can ask the user to confirm his/her identity by asking a secret question. The sample is evaluated/analyzed using the methods described above for the phonetic speech analyzer 20 over the sample period and outputs the phonetic classes for each point in time. As depicted in FIG. 2, steps 225-240 occur prior to step 245, however, the order can be reversed.

At step 250, the output phonetic classes are compared with either the available pronunciations from the name dictionary 30 or the pronunciation(s) created in step 235 from the Rules 35.

The voice communication system 1 via the processor 30, selects a pronunciation for use based upon the comparison. The selected pronunciation is set as the pronunciation for subsequent interactions. At step 255, the processor 40 determines if there is a match with one of the available pronunciations. A match is defined using a speech recognition distance determined and a distance threshold. The distance is the difference between an available pronunciation (from either steps 240 or 235) and the analyzed speech sample in the form of the phonetic classes. The distance threshold is a parameter that can be set by an operator of the voice communication system 1. The distance threshold is an allowable deviation or tolerance. Therefore, even if there is not an exact match, as long as the distance is less than the distance threshold, the pronunciation can be used. The larger the distance threshold is, the greater the acceptable deviation is. If the processor 40 determines that there is no match (“N” at step 255), i.e., recognition distance is above the distance threshold, there is no reliable match found and a second pass through the name dictionary 30 occurs or a different pronunciation is created from the pronunciations rules storage 35 at step 260. The second pass through the name dictionary 30 will result in the retrieved pronunciations from the first and later tiers for comparison, i.e., more alternative pronunciations are retrieved. Additionally, more alternatives are created using the Rules. The comparison is repeated (step 250) until a reliable match is found, i.e., recognition distance is below the distance threshold (“Y” at step 255).

Once a reliable match is found (“Y” at step 255), the pronunciation is set at step 265 and is included in the user profile and stored in the user profile storage 25. During any subsequent interaction of the user or person with the voice communication system 1, the pronunciation contained in the user profile is sent to the text-to-speech converter 45. Additionally, the pronunciation can be used to select from a database of stored speech patterns and phrases. In effect, the voice communication system 1, will pronounce the name the same way the user does.

While FIG. 2 illustrates a method for customizing the pronunciation of a user's name, the method can be used to customize the pronunciation of other words, such as, but not limited to, regional pronunciations of an address.

The use of the voice communication system 1 to personalize service interactions with a person such as a user will lead to a) more user satisfaction with the provider company, higher “take” rates (e.g., for offers to participate in automated town halls and robocalls), higher trust of service provider, higher user compliance, and an increased ease-of-use (e.g., for apartment security).

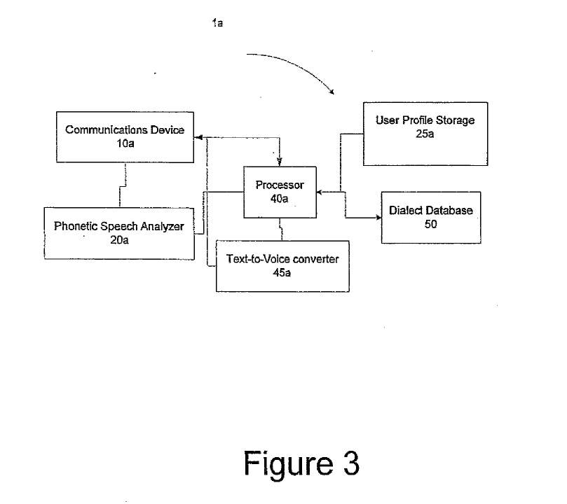

FIG. 3 illustrates a second exemplary voice communication system 1a in accordance with the invention.

The voice communication system 1a allows for the interactions with users to be adapted to individual users by analyzing their speech patterns (speaking style, word choice and dialect). This information can be stored for present or future use, updated based on subsequent interactions and used to direct a text-to-speech and/or interactive voice response system in word and phrase choice, pronunciation and recognition.

The second exemplary voice communication system 1a is similar to the voice communication system 1 described above and common or similar components will not be described again in detail.

The second exemplary voice communication system 1a includes a communications device 10a, a phonetic speech analyzer 20a, processor 40a and a text-to-speech converter 45a. Additionally, the second exemplary voice communication system 1a includes a user profile storage 25a and a dialect database 50 (instead of a name dictionary 30 and pronunciations rules storage 35).

The user profile stored in the user profile storage 25a is similar to the profile stored in user profile storage 25, however, the user profile includes additional speech profile information such as, but not limited to, a selected dialect for recognition and synthesis, a word-choice table, and other speech related information. The user account can include multiple parties within the user file. For example, if an account belongs to a family, a wife and husband would both be included in the file and a personal profile for each will be included in the user profile.

Table 1 illustrates an example of a portion of the user profile which depicts the speech profiles for a user:

| User Acct | TTS Dialect | ASR Dialect | Word Choice |
|---|---|---|---|
| ID | Class | Class | Table |
| 546575 | New England | New England | User1 |

The illustrated dialect shown in Table 1 is only for exemplary purposes, and uses a regional description. However, a more detailed dialect description, describing how a user pronounces individual letters or phonemes, could also be used.

The TTS dialect class is the dialect used for voice recognition of the user. The ASR dialect class is the dialect used for generating a synthesized voice. The dialects for the recognizer and synthesizer can be different. A word choice table includes a list of words or phrases which the user typically substitutes for a standard or common word or phrase. The word choice table is regularly updated based on the user's speech. After each interaction with the user, the voice communication system 1a analyzes the user's speech and updates the word choice table based upon the words the user spoke.

Table 2 illustrates an exemplary word choice table:

Word Choice Table: User1

| Standard Word | Replacement |
|---|---|
| Submarine Sandwich | Hoagie |

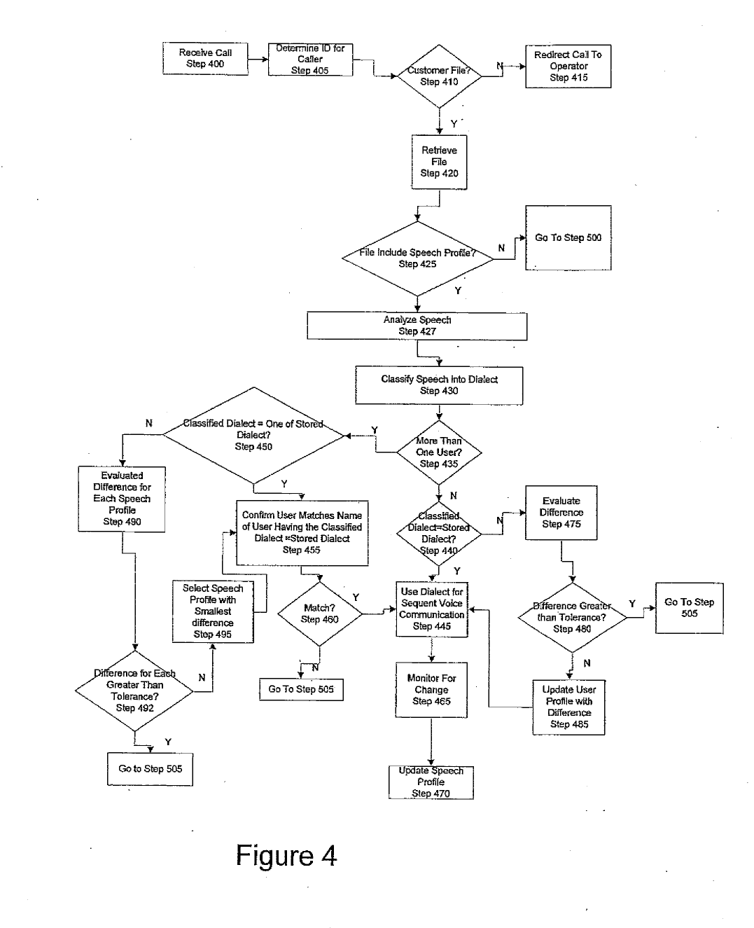

The processor 40a is programmed with a program which causes it to perform at least the methods described in FIGS. 4-6.

The phonetic speech analyzer 20a is adapted to analyze a speech sample to classify the speech into a dialect from speaking style, word choice and phoneme characteristics.

The dialect database 50 includes a list of pre-defined set of dialects indexed by name. All of the attributes for each dialect are included in the dialect database. The attributes are continuously updated based upon the voice communication system 1a interaction with people. Additionally, new dialects can be added based upon common differences among the users (people) which the voice communication system 1a interacts. The dialect can be based upon country and region, such as California, rural Appalachian, southern urban, New England and the like.

FIG. 4 illustrates a flow chart for customized voice communication in accordance with the invention. Steps 400-420 are similar to the steps described in FIG. 2 (steps 200-220) and will not be described herein again. Similarly, although FIG. 4 illustrates that the call is received by the system 1a, the voice communication system 1a can initiate the call. If the voice communication system 1a initiates the call, step 400 is replaced with initiate a call (steps 405-420 would be eliminated). The ID for the caller would be known since the voice communication system 1a initiated the call. Additionally, the user file and user profile would also be known.

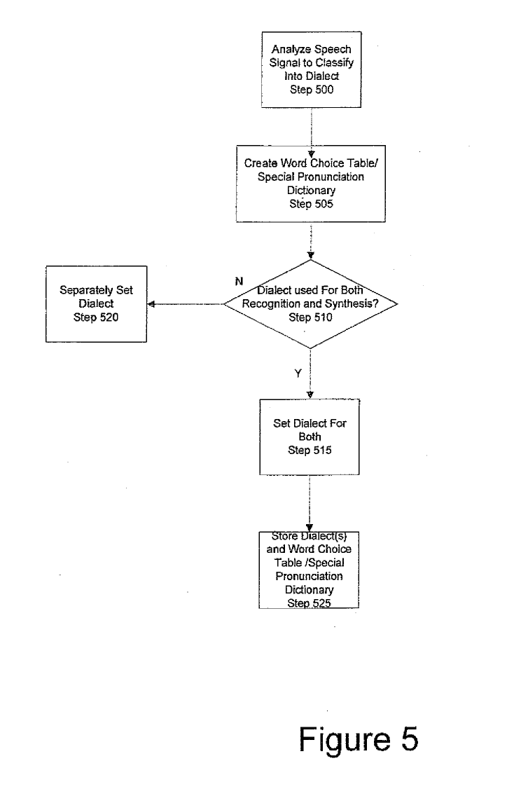

At step 425, the processor 40a determines if the user profile includes a speech profile. The speech profile includes the dialect, word choice and common user pronunciations. If the user profile does not include a speech profile (“N” at step 425), the method proceeds to step 500, where a speech profile is created. The creation of the speech profile will be described in detail later with respect to FIG. 5.

If the user profile does include a speech profile (“Y” at step 425), the phonetic speech analyzer 20a analyzes a sample of the user's speech at step 427 to classify a dialect at step 430. The analysis and classification is based upon style, word choice, and phoneme characteristics. In particular, the analysis examines speech characteristics and features most useful to distinguish between dialect classes. Typically, speech recognition involves methods of acoustic modeling, (e.g., HMMs of cepstral coefficients) and language modeling (e.g., finding the best matching words in a specified grammar by means of a probability distribution). In this case, the analysis is focused on specific speech features that distinguish dialect classes, e.g., pronunciation and phonology (word accent), prosody/intonation, vocabulary (word choice), and grammar (word order).

At step 435, the processor 40a determines the number of users or speech profiles that are included in the subject user profile. As noted above, a given user profile can include speech profiles for a family.

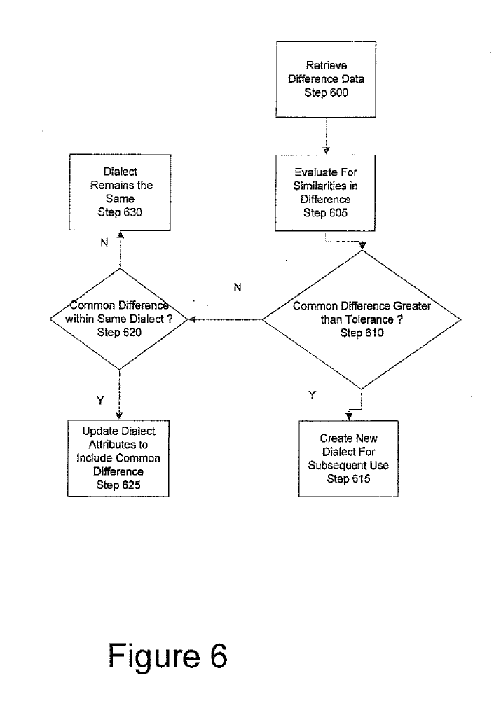

If there is only one speech profile in the user profile (“N” at step 435), the dialect in the speech profile is compared with the classified dialect from the sample speech at step 440. If there is a match (“Y” at step 440), the speech profile is used for subsequent voice communication at step 445. If there is no match (“N” at step 440), then the difference is evaluated at step 475. The attributes of the speech sample are directly compared with the attribute of the stored dialect from the speech profile using the dialect database 50 to determine a recognition distance. The distance is compared with a tolerance or a distance threshold at step 480. The distance threshold is a parameter that can be set by an operator of the voice communication system 1a. The distance threshold is an allowable deviation or tolerance. Therefore, even if there is not an exact match, then as long as the distance is less than the distance threshold, the dialect can be used. The larger the distance threshold is, the greater the acceptable deviation is. As long as any differences are minor, i.e., less than the distance threshold (“N” at step 480), the pre-set dialect can still be used (step 445). The user profile is updated to record these differences at step 485. The differences are recorded for subsequent analysis both for a particular user and across users. This analysis will be described later in detail with respect to FIG. 6. If the differences are word choice and pronunciations, the word choice table and pronunciation can also be updated at step 485. If at step 480 the differences are significant (“Y” at step 480), a new speech profile is created. The method proceeds to step 505.

If there are more than one speech profile or user (“Y” at step 435), the classified dialect from the speech sample is compared with the dialects from each of the speech profiles to determine a match at step 450. For each match, the processor 40a in combination with phonetic speech analyzer 20a confirms that the actual caller is one of the users that had a dialect match, i.e., the right person at step 455. This is done by examining the speech characteristics, such as, but not limited to, speaking rate, pitch range, gender, spectrum and estimates of the speakage's age using the speech pattern.

At step 460, the processor 40a determines if there is a match, i.e., the person speaking is on the account and matches the classified dialect. If there is a match for one of the users, the speech profile is used for subsequent voice communication at step 445. If no match is found, at step 460, either a new user profile can be created, i.e., method proceeds to step 505 or an error can be announced. If at step 450, the classified dialect does not match any of the stored dialect on the speech profiles (any user associated with the account) (“N” at step 450), the method moves to step 490 and the difference is evaluated. The difference is evaluated for each speech profile (each user associated with the account) in the same manner as described above. The attribute associated with the dialects from the speech profile are compared with the attributes of the sample speech. If the difference for each of the dialects from the speech profile is greater than the tolerance (“Y” at step 492), than a speech profile is created starting with step 505. The speech profile having the smallest difference between the dialect and the sample speech will be selected at step 495 for further analysis, i.e.; process will move to step 455.

During the subsequent portion of the dialog, the phonetic speech analyzer 20a regularly monitors the speech for changes in the speech profile at step 465. Updates to the profile may include modification of word choice (does user say “hero”, “sub”, “hoagie” etc.) or updates to the user's pronunciation of works (tomato with a long or short “a” sound). The speech profile is updated based upon these changed at step 470.

FIG. 5 illustrates a method for creating a speech profile according to the invention. Step 500 is performed when a new user contacts the system 1a. This step is equivalent to step 430 and will not be described again in detail. Step 500 can be omitted if a speech sample has been already analyzed. At step 505, a word-choice table is created for the user. Table 2 is an example of the word-choice table. Initially, the word-choice table is based upon a region or location of the user and is defined by the dialect. However, as noted above, the word-choice table is regularly updated based upon the interaction with the user. Similarly, at step 505, a special-pronunciation dictionary is created based upon the dialect, i.e., initialized. Like the word-choice table, the special-pronunciation dictionary is also regularly updated based upon the interaction with the user. At step 510, a system operator can choose whether the classified dialect is to be used for both recognition and synthesis. The default can be that the dialect is used for both. If the dialect is used for both recognition and synthesis (“Y” at step 510), the processor 40a set the classified dialect for both at step 515 and the dialect, word-choice table and special pronunciation are stored in the speech profile in the user profile at step 525. If the dialect is not used for both the recognition and synthesis (“N” at step 510), the dialects are separately set at step 520.

FIG. 6 illustrates a method for updating and creating new dialects based upon common difference in accordance with the invention.

At step 600, the difference information is retrieved from each of the speech profiles, along with the actual assigned dialects. The differences are evaluated for patterns and similarities across multiple users (with both the same and different dialects) at step 605. If the differences are significant, i.e., greater than an allowable tolerance, a new dialect can be created. At step 610, the common differences are evaluated by magnitude. If the differences are greater than the tolerance (“Y” at step 610) a new dialect is created with attributes including the common differences at step 615. The dialect database 50 is updated.

If the common difference is less than the tolerance, a determination is made if users have the same dialect. If the analysis across multiple users map to the same dialect indicates a common difference between multiple users and the dialect (“Y” step 620), the defined dialect can be updated at step 625. The dialect database 50 is updated to reflect the change in the attributes of the existing dialect.

If the differences are not significant and not for the same dialect (e.g., random), then the dialect remains the same at step 630. The individually customized speech profile is still updated to account for the differences on an individual level. The process is repeated for all of the dialects that have difference information.

Alternatively, the dialect differences could be learned via clustering techniques or other means of machine learning. In this approach, dialect differences for user A could be expanded by identifying similarities to other users and updating user A's profile with entries from the similar profiles.

The features of the voice communication system 1a can be selectively enabled or disabled on an individual basis. An operator of the system can select certain features to enable. For example, the choice of dialect to use can also be made selectively. Users with strong accents or unusual dialects might take offense at a system that appears to be imitating them. Additionally, the pre-defined dialects can be defined to avoid pronunciations that users might find insulting. Furthermore, during the updating process which has been described herein, updates to pronunciation can be limited to a defined set that has been vetted by system operators. For example, a user with a German accent speaking English might pronounce “water” with an initial “V” sound. The voice communication system 1a can be configured to avoid using this pronunciation as part of the defined set for speech synthesis. A person from New England might pronounce “water” with no final “R” sound. This voice communication system 1a can be configured to include this pronunciation in the defined set for synthesis. Thus, in this example, the voice communication system 1a can update the pronunciation of water for the user from Boston, but would not update the pronunciation for the user with a German accent.

As described herein, the pronunciation dialect that is used for recognition can be separately controlled or updated from the dialect used for speech synthesis. Therefore, the dialects can be different. In the above example, updating the recognition pronunciation of “water” for the native German speaker would improve recognition accuracy. Thus the two pronunciation lexicons can be separated to improve overall system performance, as shown in Table 1.

Additionally, to make the transition appear more seamless to the user, any significant change(s) in dialect could also be accompanied by a change in voice, such as from male to female. Advantageously, this would give the user the impression that they were transferred to an individual with the appropriate language capabilities. These impressions could be enhanced with a verbal announcement to that effect.

Various aspects of the present disclosure may be embodied as a program, software, or computer instructions embodied or stored in a computer or machine usable or readable medium, which causes the computer or machine to perform the steps of the method when executed on the computer, processor, and/or machine. A computer readable medium, tangibly embodying a program of instructions executable by the machine to perform various functionalities and methods described in the present disclosure is also provided.

The systems and methods of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The computer readable medium could be a computer readable storage medium (device) or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “computer system”, “system”, “computer network” and “network” as may be used in the present disclosure may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present disclosure may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for customized voice communication comprising:
receiving a speech signal;
retrieving an user account including a user profile corresponding an identifier of a caller producing the speech signal; and
determining if the user profile include a speech profile including at least one dialect;
if the user profile includes a speech profile, the method further comprising:
analyzing using a speech analyzer the speech signal to classify the speech signal into a classified dialect;
comparing the classified dialect with each of the at least one dialect in the user profile to select one of the at least one dialect; and
using the selected one of the at least one dialect for subsequent voice communication based upon the comparing including subsequent recognition and response speech synthesis.

2. The method according to claim 1, further comprising
monitoring regularly the speech signal for differences in dialect or speech pattern.

3. The method according to claim 2, further comprising
updating the speech profile based upon the monitoring.

4. The method according to claim 3, wherein said updating includes a modification of a user choice dictionary in the speech profile.

5. The method according to claim 3, wherein said updating includes a modification of a synthesis pronunciation.

6. The method according to claim 1, wherein if the user profile does not include a speech profile, the method comprises determining the speech profile.

7. The method according to claim 6, wherein said determining comprises:
analyzing using a speech analyzer the speech signal to classify the speech signal into one of a plurality of dialects; and
creating the speech profile by storing the dialect in the user profile, the profile being identified by an identifier of a caller producing the speech signal.

8. The method according to claim 7, wherein said classifying includes analyzing a speaking style, word choice and phoneme characteristics.

9. The method according to claim 1, further comprising prompting a user to generate the speech signal.

10. The method according to claim 6, wherein said determining comprises:
analyzing using a speech analyzer the speech signal to classify the speech signal into one of a plurality of dialects;
analyzing using a speech analyzer the speech signal to create a user choice dictionary; and
creating the speech profile by storing the dialect and user choice dictionary in the user profile, the profile being identified by an identifier of a caller producing the speech signal.

11. The method according to claim 1, wherein if the comparing indicates a difference the method further comprises evaluating the difference.

12. The method according to claim 11, wherein if the difference is greater than a variable threshold, the method further comprises creating a new speech profile.

13. The method according to claim 11, wherein if the difference is less than a variable threshold, the difference is stored in the speech profile for subsequent analysis.

14. The method according to claim 1, wherein the user account includes at least two speech profiles, and the comparing includes comparing each of the speech profiles with the classified dialect.

15. The method according to claim 1, wherein the speech profile includes a dialect for use in recognition, a dialect for use in a response speech synthesis, a user-choice dictionary and a special-pronunciation dictionary.

16. The method according to claim 15, wherein the dialect for use in recognition and the dialect for use in a response speech synthesis are different.

17. The method according to claim 15, further comprising adjusting the special-pronunciation dictionary based upon a selectable criterion.

18. The method according to claim 15, further comprising updating, separately, definitions in the dialect for use in recognition and a dialect for use in a response speech synthesis.

19. The method according to claim 15, wherein when a change in dialect is implemented, the voice for the response speech synthesis is changed.

20. The method according to claim 1, wherein the method is employed in a call center.

21. The method according to claim 1, wherein the method is employed in an on-line computer game.

22. The method according to claim 1, wherein the method is employed during language education.

23. A method for customized voice communication comprising:
receiving a speech signal;
retrieving an user account including an user profile corresponding an identifier of a caller producing the speech signal;
obtaining a textual spelling of a word in the user profile;
searching a pronunciation dictionary for a list of available pronunciations for the word;
analyzing using a speech analyzer the speech signal to obtain a user pronunciation for the word to output a processed result;
comparing the processed result with each of the available pronunciations in the list of available pronunciation;
selecting a pronunciation for the word based upon the comparing; and
using the selected pronunciation for subsequent voice communication.

24. The method for customized voice communication according to claim 23, wherein the pronunciation dictionary contains a ranking of available pronunciations which is ranked according to common pronunciations, the ranking being indexed by the word.

25. The method for customized voice communication according to claim 24, wherein the ranking is based upon grouping of available pronunciations by tiers and available pronunciations ranked in a first tier is compared with the analyzed user pronunciation in a first comparison.

26. The method for customized voice communication according to claim 25, wherein if the analyzed user pronunciation does not match any of the available pronunciations ranked in the first tier during the first comparison, said comparing is repeated using available pronunciations from the first and additional tiers until a match is found, one additional tier is added per repetition.

27. The method for customized voice communication according to claim 23, wherein if the a list of available pronunciations for the word is void of any available pronunciations, the method further comprises:
creating a pronunciation from the textual spelling of the word based on at least one predefined pronunciation rule; and
comparing the created pronunciation with the processed result.

28. The method for customized voice communication according to claim 23, further comprising:
creating a pronunciation for the textual spelling of the word based on at least one predefined pronunciation rule;
comparing the created pronunciation with the processed result; and
selecting a pronunciation based the comparing of the processed result with each of the available pronunciations in the list of available pronunciation and the comparing of the created pronunciation with the processed result.

29. The method according to claim 23, wherein the identifier of a caller producing the speech signal is a caller ID for a caller.

30. The method according to claim 23, further comprising prompting a user to generate the speech signal.
